(19) United States
(12) Patent Application Publication
(10) Pub. No.: US 2008/0161049 A1
(43) Pub. Date: Jul. 3, 2008

(54) METHODS AND SYSTEMS FOR SIM-BASED RADIO TECHNOLOGY MODULES AND NON-SIM-BASED RADIO TECHNOLOGY MODULES

(76) Inventors: Isaac LAGNADO, Houston, TX (US); Monji G. Jabori, Houston, TX (US); Jay Dewnani, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/617,447

(22) Filed: Dec. 28, 2006

(51) Int. Cl. H04M 1/00

(52) U.S. Cl. 455/558

(57) ABSTRACT

A device is provided, the device having a processor and a Subscriber Identity Module (SIM) card interface coupled to the processor. The device further comprises a radio technology interface coupled to the processor, the radio technology interface being compatible with a SIM-based radio technology module and a non-SIM-based radio technology module. If a SIM-based radio technology module is installed in the radio technology interface, a SIM access event forces the SIM-based radio technology module into an inoperative state.

### BACKGROUND

Various wireless communication technologies exist. The data transfer rate (bandwidth) supported by the various wireless communication technologies differs based on factors such as the distance between transmitters and receivers, modulation complexity, operational frequency, and error correction techniques. To simplify the discussion of different wireless communication technologies, two generic categories referred to as “wi-fi” and “radio” are herein delineated. The wi-fi category is directed to technologies which support high bandwidths within a limited operational range (e.g., technologies intended for home use, office use, or limited outdoor use). For purposes of this disclosure, the Institute of Electrical and Electronics Engineers (IEEE) 802.11 protocols are part of the wi-fi category. The radio category is directed to technologies which support low bandwidths within an extended operational range (e.g., technologies intended for mobile or “on the road” use). For purposes of this disclosure, the Global System for Mobile communications (GSM) and Code Division Multiple Access (CDMA) protocols are part of the radio category.

### BRIEF DESCRIPTION OF THE DRAWINGS

For a detailed description of exemplary embodiments of the invention, reference will now be made to the accompanying drawings in which:

FIG. 1 shows a system in accordance with embodiments;

FIG. 2 illustrates a method in accordance with embodiments; and

FIG. 3 illustrates another method in accordance with embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

As desired, computing devices could implement both wi-fi and radio technologies. In such case, wireless communication can selectively be high bandwidth within a limited operational range or low bandwidth within an extended operational range. Some radio technologies (e.g., the Global System for Mobile communications (GSM)) are based on a Subscriber Identity Module (SIM) while other radio technologies (e.g., Code Division Multiple Access (CDMA)) are not based on a SIM. Embodiments comprise computing devices that selectively support a SIM-based radio technology and a non-SIM-based radio technology. If a SIM-based radio technology module is installed, embodiments are able to shut down the radio module in response to a SIM access event. For example, the SIM access event may involve removal of the SIM or removal of a component (e.g., a battery, a keyboard, a keypad, or a movable cover) that covers the SIM. If a non-SIM-based radio technology module is installed, embodiments maintain the current state of the radio module regardless of a SIM access event.

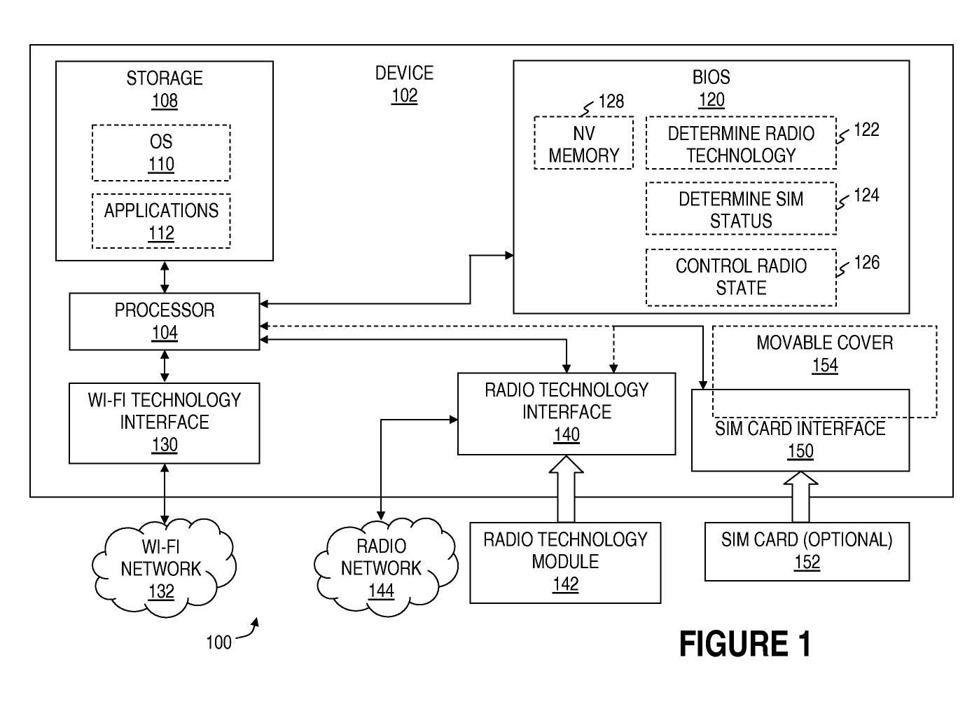

FIG. 1 shows a system 100 in accordance with embodiments. As shown in FIG. 1, the system 100 comprises a device 102 which may be, for example, a desktop computer, a laptop computer, or a handheld device (e.g., a cellular phone, a smart phone, or personal digital assistant (PDA)). The device 102 comprises a processor 104 coupled to a storage 108. The storage 108 comprises a computer-readable medium such as volatile storage (e.g., random access memory), non-volatile storage (e.g., hard disk drive), optical disk storage, “flash” memory or a combination thereof. As shown, the storage 108 stores an operating system (OS) 122 and other applications 124 which are executable by the processor 104.

The device 102 also comprises a “wi-fi” technology interface 130 coupled to the processor 104. The wi-fi technology interface 130 enables the device 102 to send data to and/or receive data from a wi-fi network 132. In at least some embodiments, the wi-fi technology interface 130 and the wi-fi network 132 are based on an Institute of Electrical and Electronics Engineers (IEEE) 802.11 protocol. In some embodiments, the wi-fi technology interface 130 is implemented as a wireless local area network (WLAN) card. Although FIG. 1 shows the device 102 with the wi-fi technology interface 130, some embodiments could forego the wi-fi technology interface 130.

As shown, the device 102 further comprises a radio technology interface 140 coupled to the processor 104. The radio technology interface 140 is configured to receive a radio technology module 142 which may be either a SIM-based module radio technology module or a non-SIM-based radio technology module. In other words, a manufacturer, vendor, or user of the device 102 can select one of various available or future radio technology modules for implementation with the device 102. If desired, a manufacturer, vendor, or user can replace a SIM-based radio technology module with a non-SIM-based radio technology module or vice versa.

Together, the radio technology interface 140 and the radio technology module 142 enable the device 102 to send data to and/or receive data from a radio network 144. In at least some embodiments, the radio technology module 142 and the radio network 144 operate using a SIM-based GSM technology such as General Packet Radio Service (GPRS), Universal Mobile Telecommunications System (UMTS) or High-Speed Downlink Packet Access (HSDPA). Alternatively, the radio technology module 142 and the radio network 144 operate using a non-SIM-based CDMA technology such as single-carrier Radio Transmission Technology (1×RTT), Evolution Data-Only (EVDO) or Evolution Data and Voice (EVDV).

As shown, the device 102 further comprises a SIM card interface 150 which can either be coupled to the processor 104 or to the radio technology interface 140. The SIM card interface 150 is configured to receive a SIM card 152 which is optional. If the radio technology module 142 is SIM-based, inserting a valid SIM card 152 into the SIM card interface 150 enables a user to access the radio network 144, for example, as part of a subscription. If the radio technology module 142 is non-SIM-based, a SIM card 152 is not needed and could be ignored, or otherwise ineffective, if inserted into the SIM card interface 150.

In at least some embodiments, a movable cover 154 covers the SIM card interface 150. In order to access the SIM card interface 150, a user or vendor removes the movable cover 154 and exposes the SIM card interface 150. The SIM card 152 can then be inserted into the SIM card interface 150 and the movable cover 154 can be restored to a position that covers the SIM card interface 150. As an example, in some embodiments, the movable cover 154 comprises a battery. Alternatively, the movable cover 154 comprises a keyboard or keypad (e.g., of a laptop). Alternatively, the movable cover 154 comprises part of the device's chassis. Alternatively, the movable cover 154 could be a combination of covers that are selectively removed to expose the SIM card interface 150.

In at least some embodiments, opening or removing the removable cover 154 corresponds to a SIM access event. Additionally or alternatively, insertion or removal of a SIM card could correspond to a SIM access event. In either case, SIM access events are detectable and monitored by the device 102. Upon detection of a SIM access event, the device 102 selectively adjusts the state of the radio technology module 142. For example, if the radio technology module 142 is SIM-based and is operative, the SIM access event causes the radio technology module 142 to cease radio transmissions or to otherwise become inoperative. If the radio technology module 142 is SIM-based and is inoperative, the radio technology module 142 will not become operative until a valid SIM card has been inserted into the SIM card interface 150. A SIM card can be validated, for example, by comparing the SIM's unique identifier with a corresponding identifier securely stored in the device 102. If the device 102 does not store an identifier or if the stored identifier does not match the SIM's unique identifier, the radio technology module 142 remains inoperative. Thus, if the device 102 implements a SIM-based radio technology module, only one SIM enables the device 102 to access the radio network 144 (i.e., each device that accesses a SIM-based radio network is associated with only one SIM and SIMs cannot be shared between devices).

As shown, the device 102 further comprises a Basic Input/Output System (BIOS) 120 in communication with the processor 104. In at least some embodiments, the BIOS 120 is stored on a computer-readable medium and comprises instructions that, when executed, enable the device 102 to control the operative state of the radio technology module 142 based on the type of radio technology being implemented (SIM-based or non-SIM-based) and the occurrence of SIM access events. As shown, the BIOS 120 stores determine radio technology instructions 122, determine SIM status instructions 124 and control radio state instruction 126.

When executed, the determine radio technology instructions 122 causes the BIOS 120 to determine whether the radio technology module 142 is SIM-based or non-SIM-based. In at least some embodiments, the BIOS 120 stores a table of compatible radio technology modules and related information. For example, the table can store information such as module type identifiers and a corresponding SIM/non-SIM identifier for each module type identifier. In at least some embodiments, the BIOS's non-volatile memory 128 stores the table. During the device's boot process, the determine radio technology instructions 122 cause the processor 104 to verify whether the radio technology module 142 has been installed. If the radio technology module 142 has not been installed, the boot process continues and no radio technology module will be available during runtime of the device 102. If the radio technology module 142 has been installed, the determine radio technology instructions 122 cause the processor 104 to obtain a module type identifier from the radio technology module 142. The module type identifier is then compared with module type identifiers in the table.

If there is not a match between module type identifiers, the boot process continues but the radio technology module 142 will be inoperative during runtime of the device 102 (i.e., the radio technology module 142 is incompatible or is not unauthorized to operate on the device 102). If desired, a message describing the inoperative state of the radio technology module 142 may be presented to the user of the device 102 (e.g., via a Liquid Crystal Display (LCD) panel or other display). If there is a match between module type identifiers, the determine radio technology instructions 122 authorize the radio technology module 142 to operate (or to be activated later) and the boot process continues. During runtime, the SIM/non-SIM identifier associated with the radio technology module 142 can be used to selectively adjust the radio technology module's operation based on SIM access events. As previously mentioned, a SIM access event could correspond to removing the SIM card 152 from the SIM card interface 150 and/or exposing the SIM card interface 150 by removing a movable cover 154.

When executed, the determine SIM status instructions 124 cause the processor 104 to monitor the status of SIM access events. In at least some embodiments, the SIM status instructions 124 also cause the processor 104 to monitor the status of a SIM card presence signal. For example, the SIM card presence signal may be asserted whenever the SIM card 152 is present in the SIM card interface 150 and de-asserted whenever the SIM card 152 is absent from the SIM card interface 150. In at least some embodiments, the determine SIM status instructions 124 enable storage of indicators that correspond to the SIM card presence signal or the SIM access events being monitored. If a SIM access event occurs during runtime, the determine SIM status instructions 124 may cause power to the SIM card interface 150 to be cut off to prevent possible damage to the SIM card 152 while inserting or removing the SIM card 152.

When executed, the control radio state instructions 126 enable the radio technology module 142 to be selectively powered off or to be otherwise inoperative. Table 1 shows radio control states in accordance with at least some embodiments.

TABLE 1

| SIM card status | Radio Module Type | Radio state |
|---|---|---|
| Present | SIM-based | Maintain current state |
| Absent | SIM-based | Force “Off” state |
| Present | Non-SIM-based | Maintain current state |
| Absent | Non-SIM-based | Maintain current state |

As shown in Table 1, if a SIM card is present and the radio module type is SIM-based, the current radio state (e.g., the on/off state) of the radio technology module 142 is maintained. If the SIM card is absent and the radio module type is SIM-based, the radio technology module 142 is forced to an off state or another inoperative state. If the SIM card is present and the radio module type is non-SIM-based, the current radio state of the radio technology module 142 is maintained. Finally, if the SIM card is absent and the radio module type is non-SIM-based, the current radio state is maintained. Table 1 illustrates that a non-SIM-based radio technology module maintains its current state regardless of the presence or absence (e.g., insertion/removal) of a SIM card. In contrast, a SIM-based radio technology module maintains its current state only if the SIM card is present. If a SIM card is absent, a SIM-based radio technology module is forced off or is otherwise inoperative. As previously mentioned, a radio technology module (SIM-based or non-SIM-based) also may be inoperative if not properly authenticated during the boot process. In at least some embodiments, the control radio state instructions 126 control the radio states based on a SIM card presence indicator and a radio module type indicator.

In at least some embodiments, radio control states can be determined according to SIM access events rather than the presence or absence of a SIM card. Table 2 shows radio control states in accordance with at least some embodiments.

TABLE 2

| SIM access | | |
|---|---|---|
| event occurs? | Radio Module Type | Radio state |
| Yes | SIM-based | Force “Off” state |
| No | SIM-based | Maintain current state |
| Yes | Non-SIM-based | Maintain current state |
| No | Non-SIM-based | Maintain current state |

As shown in Table 2, if a SIM access event occurs and the radio module type is SIM-based, the radio technology module 142 is forced to an off state or another inoperative state. If a SIM access event does not occur and the radio module type is SIM-based, the current radio state (e.g., the on/off state) of the radio technology module 142 is maintained. If a SIM access event occurs and the radio module type is non-SIM-based, the current radio state of the radio technology module 142 is maintained. Finally, if a SIM access event does not occur and the radio module type is non-SIM-based, the current radio state of the radio technology module 142 is maintained. Table 2 illustrates that a non-SIM-based radio technology module maintains its current state regardless of SIM access events (e.g., removal of a movable cover to expose the SIM card interface 150). In contrast, a SIM-based radio technology module maintains its current state only if SIM access events do not occur. If a SIM access event occurs, a SIM-based radio technology module is forced off or is otherwise inoperative. Again, a radio technology module (SIM-based or non-SIM-based) also may be inoperative if not properly authenticated during the boot process. In at least some embodiments, the control radio state instructions 126 control the radio states based on SIM access event indicators and a radio module type indicator.

In at least some embodiments, SIM access events and a SIM card presence signal are both used. For example, if a SIM access event causes a SIM-based radio technology module to enter an off state or another inoperative state, a SIM card presence indicator can still be used to determine when the SIM-based radio technology module can enter an operative state again. As an example, if a SIM card presence indicator shows a SIM card is present and a SIM access event indicator has been cleared (i.e., the SIM card interface 150 is no longer exposed), a SIM-based radio technology module can become operative. If a SIM card is removed and inserted during runtime, some embodiments require that the SIM-based radio technology module and the SIM card be authenticated again by rebooting the device 102. In this manner, the security of SIM-based radio communications is assured.

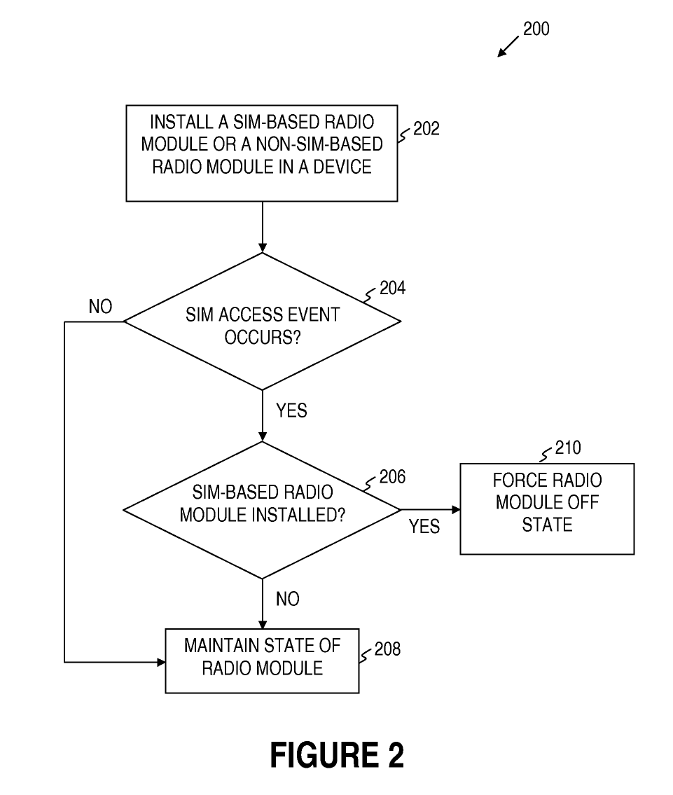

FIG. 2 illustrates a method 200, in accordance with embodiments, that comprises installing a SIM-based radio module or a non-SIM-based radio module in a device (block 202). If a SIM access event does not occur (determination block 204), the state (e.g., the on/off state) of the radio module is maintained (block 208). If a SIM access event does occur (determination block 204), the method 200 determines if a SIM-based radio module was installed (determination block 206). If a SIM-based radio module was installed (determination block 206), the radio module is forced to an off state or another inoperative state (block 210). If a SIM-based module was not installed (determination block 206), the state of the radio module is maintained (block 208). In at least some embodiments, the SIM access event corresponds to inserting/removing a SIM card from a SIM card interface. In alternative embodiments, the SIM access event corresponds to exposing a SIM card interface (e.g., by removing a movable cover). The movable cover could be, for example, a battery, a keyboard, a keypad, or part of a device chassis.

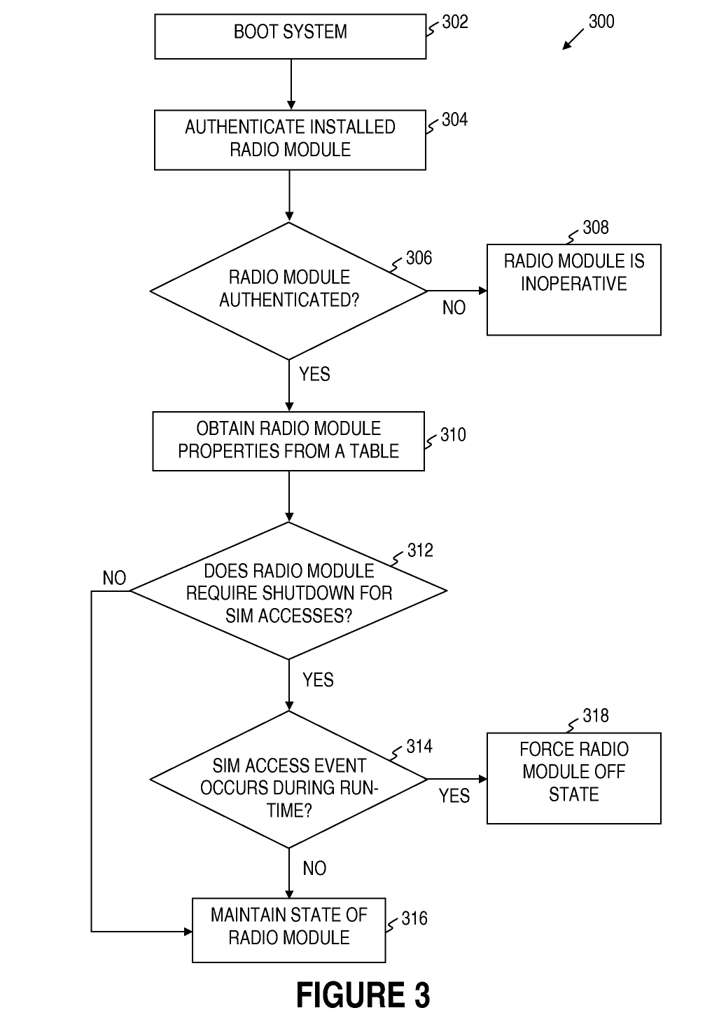

FIG. 3 illustrates a method 300, in accordance with embodiments, that comprises booting a system (block 302). During the boot process, an installed radio module is authenticated (block 304). For example, the authentication may involve comparing a radio module identifier of the installed radio module with a list of radio module identifiers. If there is a match, the installed radio module is successfully authenticated. Otherwise, the installed radio module is not authenticated. If the radio module is not authenticated (determination block 306), the radio module is inoperative (block 308). If the radio module is authenticated (determination block 306), radio module properties are obtained from a table (block 310). In at least some embodiments, the radio module properties identify whether the radio module requires shutdown for SIM accesses. If the radio module does not require shutdown for SIM accesses (determination block 312), the state of the radio module is maintained (block 316). If the radio module requires shutdown for SIM accesses (determination block 312), the method 300 determines if a SIM access event occurs during runtime (determination block 314). If a SIM access event occurs during runtime (determination 314), the radio module is forced to an off state or another inoperative state (block 318). If a SIM access event does not occur during runtime (determination block 314), the state of the radio module is maintained (block 316). In some embodiments, the SIM access event corresponds to inserting/removing a SIM card from a SIM card interface. In alternative embodiments, the SIM access event corresponds to exposing a SIM card interface (e.g., by removing a movable cover). The movable cover could be, for example, a battery, a keyboard, a keypad, or part of a device chassis.

The above discussion is meant to be illustrative of the principles and various embodiments of the present invention. Numerous variations and modifications will become apparent to those skilled in the art once the above disclosure is fully appreciated. For example, in some embodiments, multiple radio technology modules could be implemented with one device. Such a device could be useful for a user who wants to use CDMA services in the U.S. and GSM services in Europe. In these embodiments, one or more radio technology interfaces would support multiple radio technology modules. It is intended that the following claims be interpreted to embrace all such variations and modifications.

What is claimed is:

1. A device, comprising:
a processor;
a Subscriber Identity Module (SIM) card interface coupled to the processor; and
a radio technology interface coupled to the processor, the radio technology interface being compatible with a SIM-based radio technology module and a non-SIM-based radio technology module,
wherein, if a SIM-based radio technology module is installed in the radio technology interface, a SIM access event forces the SIM-based radio technology module into an inoperative state.

2. The device of claim 1, wherein the radio technology interface supports one radio technology module at a time.

3. The device of claim 1, wherein radio technology interface supports multiple radio technology modules at a time.

4. The device of claim 1 wherein, if a non-SIM-based radio technology module is installed in the radio technology interface, the SIM access event is ignored.

5. The device of claim 1 further comprising a SIM card, wherein the SIM access event comprises removing the SIM card from the SIM card interface.

6. The device of claim 1 further comprising a movable cover that covers the SIM card interface, wherein the SIM access event comprises moving the movable cover to expose the SIM card interface.

7. The device of claim 6 wherein the movable cover is selected from the group consisting of a battery, a keyboard, a keypad, and part of a chassis of the device.

8. The device of claim 1 further comprising a Basic Input/Output System (BIOS) in communication with the processor, wherein the BIOS stores instructions that, when executed during a boot process, enable identification of a radio technology module installed in the radio technology interface as one of a SIM-based module and a non-SIM-based module.

9. The device of claim 1 further comprising a Basic Input/Output System (BIOS) in communication with the processor, wherein the BIOS stores instructions that, when executed during runtime, enable monitoring occurrences of the SIM access event.

10. The device of claim 1 further comprising a Basic Input/Output System (BIOS) in communication with the processor, wherein the BIOS stores instructions that, when executed during runtime, enable selectively changing a state of a radio technology module installed in the radio technology interface based on SIM card presence indicator and a radio module type indicator.

11. The device of claim 1 further comprising a wi-fi network interface coupled to the processor for sending data to and receiving data from a wi-fi network.

12. A method, comprising:
installing a radio technology module in a device, the radio technology module being one of a Subscriber Identity Module (SIM)-based module and a non-SIM-based module;
if a SIM access event occurs and a SIM-based radio technology module is installed, forcing the SIM-based radio technology module into an inoperative state; and
if the SIM access event occurs and a non-SIM-based radio technology module is installed, maintaining an operational state of the non-SIM-based radio technology module.

13. The method of claim 12 further comprising, during a boot process of the device, authenticating the installed radio technology module by comparing an identifier of the installed radio technology module with a list of identifiers.

14. The method of claim 13 further comprising, upon successful authentication, determining whether the installed radio technology module is one of a SIM-based module and a non-SIM-based module based on information stored in a table.

15. The method of claim 12 further comprising determining if the SIM access event occurs by monitoring a SIM card presence signal.

16. The method of claim 12 further comprising determining if the SIM access event occurs by monitoring exposure of a SIM card interface.

17. The method of claim 12 further comprising maintaining the inoperative state of the SIM-based radio technology module until a SIM card presence signal indicates a valid SIM card is present in the device.

18. The method of claim 12 further comprising selectively utilizing both wi-fi technology and radio technology for wireless communications of the device.

19. The method of claim 12 wherein forcing the SIM-based radio technology module into an inoperative state comprises shutting off power to the SIM-based radio technology module.

20. A Basic Input/Output System (BIOS) stored on a computer-readable medium, the BIOS comprising:
determine radio technology instructions that, when executed, enable a radio technology module to be identified as one of a Subscriber Identity Module (SIM)-based module and a non-SIM-based module;
determine SIM status instructions that, when executed, enable monitoring of a SIM access event; and
control radio state instructions that, when executed, enable a radio technology module to selectively be powered off based on a radio module type indicator and a SIM access event indicator.

21. The BIOS of claim 20 wherein the control radio state instructions cause the radio technology module to be powered off if the radio module type indicator indicates a SIM-based radio module and the SIM access event indicator indicates a SIM card is absent.

22. The BIOS of claim 20 wherein the control radio state instructions cause the radio technology module to be powered off if the radio module type indicator indicates a SIM-based radio module and the SIM access event indicator indicates a SIM card interface is exposed.

23. The BIOS of claim 20 wherein the control radio state instructions cause power to be maintained to the radio technology module if the radio module type indicator indicates a SIM-based radio module and the SIM access event indicator is de-asserted.

24. The BIOS of claim 20 wherein the control radio state instructions cause power to be maintained to the radio technology module if the radio module type indicator indicates a non-SIM-based radio module regardless of the SIM access event indicator.
